(19) United States
(12) Patent Application Publication
(10) Pub. No.: US 2002/0195205 A1
(43) Pub. Date: Dec. 26, 2002

(54) Coating film transfer tool

(76) Inventor: Kazuya Watanabe, Osaka-shi (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/156,600

(22) Filed: May 28, 2002

(30) Foreign Application Priority Data
Jun. 21, 2001 (JP) 187994/2001

(51) Int. Cl. B32B 35/00

(52) U.S. Cl. 156/577

(57) ABSTRACT

A small-sized coating film transfer tool is provided, in which a transfer head is capable of turning relative to a casing. A bearing hole extends widthwise through the main body of a transfer head, and an insertion member, provided at the end of the casing, is inserted into the bearing hole. In the assembly of the tool, the insertion member is inserted into the bearing hole of the transfer head, and, when the casing is united with its cover, an end of the insertion member is engaged with a part of the cover. The inside of the bearing hole of the transfer head comes into line contact with the insertion member, allowing the transfer head to turn smoothly relative to the casing about the contact location.

### FIELD OF THE INVENTION

This invention relates to a coating film transfer tool for transferring a film to a receiving surface. The film may be a coating film for correction, an adhesive, a decorative coating film, or the like.

### BACKGROUND OF THE INVENTION

FIG. 6a shows a conventional coating film transfer tool 100 with its cover removed. This coating film transfer tool comprises a casing 200 having two reel support shafts 22a and 22b, a transfer head 300, which protrudes outwardly from an end of the casing and has a pressing transfer part 340 at its tip, a tape supply reel 24b and a take-up core 24a, which are rotatably mounted on the support shafts 22a and 22b respectively, and a transfer tape T comprising a base material tape coated with a coating film. The cover of the casing 200 is not shown.

A transfer tape T is initially wound on the supply reel 24b. As the tape T is unreeled from the supply reel 24b, it is separated into a coating film and a base material tape at the transfer part 340, and the coating film is transferred to a receiving surface. Only the base material tape is wound onto the take-up core 24a.

In the coating film transfer tool 100 of FIG. 6a, the take-up core 24a and the supply reel 24b are connected by an endless rubber belt B, which causes the take-up core and supply reel to rotate cooperatively.

A transfer head 300 comprises a main head body 320, having an elongated pressing part 340 extending across the width of the main head body 320 at its tip, and a cylinder-shaped support shaft 360. A bearing 260, which supports the support shaft 360 of the transfer head 300, is provided in the casing 200. FIG. 6(b) is a perspective view of the transfer head 300 and the bearing part 260 and FIG. 6(c) is a cross-sectional view taken on plane c-c of FIG. 6(a). As shown in FIG. 6(b), the support shaft 360 of the transfer head 300 is cylinder-shaped and is rotatably supported by the bearing 260.

By the above-described structure, even when the casing 200 is inclined while the coating film transfer tool 100 is being used, the transfer head 300 rotates in the direction shown by an arrow of FIG. 6(c) so that the entire length of the pressing transfer part 340 of the main body 320 of the head is pressed against a receiving surface. As a result, the coating film transfer tool 100 is capable of good transfer performance. However, because of the space needed to accommodate the bearing 260, the distance from the supply reel 2b to the opposite end of the casing inevitably becomes large, and the overall size of the coating film transfer tool 100 becomes large as a result.

Transfer tapes are continually being made thinner, and thinner tape base material films have weaker elasticity. When a transfer tape T having weak elasticity is used in a coating film transfer tool 100, in which the distance from the supply reel 24b to the transfer head at the opposite end of the casing is large, another problem arises. That problem is the ease with which twisting, meandering, or folding of the transfer tape T can occur between the supply reel and the transfer head at the opposite end of the casing.

In a coating film transfer tool disclosed in Unexamined PCT National Phase Publication No. 502211/1993, a transfer head is mounted to a casing by inserting a convex part provided in the casing into a concave part provided on the transfer head so that they are in sliding engagement with each other. By eliminating the support shaft and attaching the transfer head to the casing by inserting a convex part into a small concave part, the distance from the supply reel to the transfer head at the opposite end of the casing can be shortened, and the coating film transfer tool can be miniaturized. In this coating film transfer tool, when the casing is inclined while the tool is in use, the transfer head rotates by the sliding engagement of the concave and convex parts, and consequently the whole pressing surface of the transfer head is pressed against a receiving surface.

However, in case of the coating film transfer tool of Unexamined PCT National Phase Publication No. 502211/1993, if there is a breakage or distortion on the surfaces of the concave and convex parts, the transfer head becomes incapable of rotating smoothly. Therefore, the finish of the surfaces of the concave and convex parts requires close attention in the manufacturing process, which is time-consuming.

### BRIEF SUMMARY OF THE INVENTION

The coating film transfer tool in accordance with the invention comprises a casing, a supply core and a take-up core, both disposed rotatably in the casing, a transfer head having a main body, a pressing part protruding from an end of the casing, and a transfer tape wound on the supply core. The transfer tape includes a tape base material which extends around the pressing part to the take-up core, and a transferable coating film which is separable from the tape base material, at the location of the pressing part, for transfer onto a receiving surface while the remaining tape base material is wound onto the take-up core. To this extent, the transfer tool in accordance with the invention is similar to a conventional coating film transfer tool. The coating film transfer tool in accordance with the invention departs from the conventional transfer tool in that it has a bearing hole in the main body of the transfer head, the bearing hole extending in a direction transverse to the direction in which the pressing part protrudes from the casing, and an insertion member extending into the bearing hole at the end of the casing from which the pressing part protrudes. The bearing hole is preferably tapered, having its smallest cross-section approximately at the center of the transfer head. In a most preferred embodiment, the bearing hole is a through hole through which the insertion member extends.

The transfer head is mounted in the casing by insertion of the insertion member into the bearing hole of the main body of the transfer head. The transfer head can be rotated relative to the casing while being supported by the insertion member. When the coating film transfer tool is inclined while being used, the transfer head rotates relative to the casing so that the entire pressing surface of the transfer part presses against a receiving surface, and effective transfer of the coating film is achieved. It is not necessary to provide extra space in the casing in order to mount the transfer head rotatably, as was the case in the past. Accordingly, the coating film transfer tool can be miniaturized.

### BRIEF DESCRIPTION OF DRAWINGS

FIG. 1(a) is a top view of a coating film transfer tool of a first embodiment of the invention, with its cover removed;

FIG. 1(b) is a perspective view of a transfer head used in FIG. 1(a);

FIG. 1(c) is a cross-sectional view taken on plane c-c of FIG. 1(a);

FIG. 2(a) and FIG. 2(b) are enlarged, partial perspective views which show coating film transfer tools in an inclined condition;

FIG. 3(a) is a cross-sectional view of a transfer head and an insertion member in a coating film transfer tool in accordance with a second embodiment of the invention;

FIG. 3(b) is a cross-sectional view of a transfer head and an insertion member in a coating film transfer tool in accordance with a third embodiment of the invention;

FIG. 4 is a perspective view of a transfer head of a coating film transfer tool in accordance with a fourth embodiment according to the invention;

FIG. 5 is an exploded perspective view of a transfer head and an insertion member in a coating film transfer tool in accordance with a fifth embodiment of the invention;

FIG. 6(a) is a top view of a conventional coating film transfer tool with its cover removed;

FIG. 6(b) is an exploded perspective view of the transfer head of the transfer tool of FIG. 6(a); and

FIG. 6(c) is a cross-sectional view taken on plane c-c of FIG. 6(a).

### DETAILED DESCRIPTION OF THE PREFERRED EMBODIMENTS

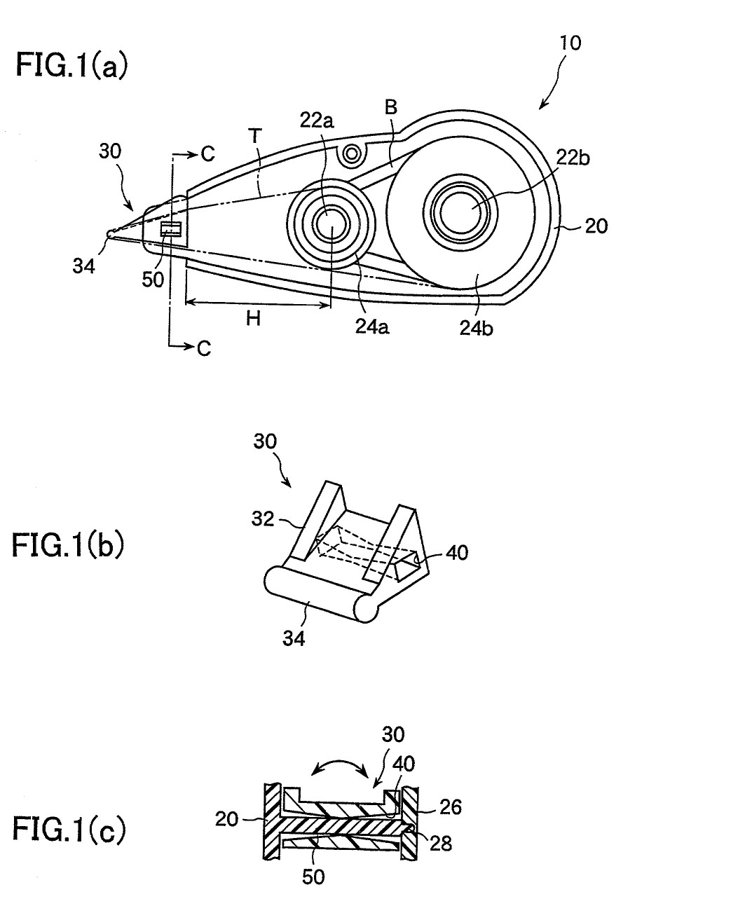

As shown in FIG. 1(a), a coating film transfer tool 10 according to the invention comprises a casing 20 having two support shafts 22a and 22b, a transfer head 30 which is provided at an end of the casing and has an elongated pressing part 34 at its end, extending across the width of the transfer head. The transfer tool 10 also has a supply core 24b and a take-up core 24a, which are rotatably mounted on the support shafts 22a and 22b respectively, and a transfer tape T comprising a base material tape coated with a coating film. The opening at the side of the casing 20 is closed by a cover (not shown). As in the past, the transfer tape T which is wound around the supply core 24b is unreeled and separated into a coating film and a base material tape at the pressing part 34, the coating film is transferred onto a receiving surface, and only the base material tape is reeled onto the take-up core 24a.

As shown in FIG. 1(b), the transfer head 30 comprises a main body 32, on an end of which the pressing part 34 is provided. A bearing hole 40, having a rectangular transverse cross-section, extends through the main body 32 of the transfer head 30. The distance between the upper and lower walls of the bearing hole 40 increases from a point midway along the length of the hole toward both ends, so that the bearing hole is tapered, with the area of the rectangular transverse cross section of the bearing hole 40 being smallest at the center of the main body 32, and gradually increasing toward both ends. At the end of the casing, a pillar shaped insertion member 50, having a uniform, rectangular, transverse cross-section, is fixed to, and extends perpendicularly from, the side of the casing 20. A recess 28, which receives a projection extending from the opposite end of the insertion member 50 is provided on the inside face of a cover 26 (see FIG. 1(c)).

With the insertion member 50 of the casing 20 extending through the bearing hole 40 of the transfer head 30, the transfer head 30 is securely mounted in the coating film transfer tool 10 by enclosing the casing 20 with the cover 26, inserting the projection at the end of the insertion member 50 into the recess 28 on the inside face of the cover 26. Since the upper and lower walls of the bearing hole 40 are formed so that the bearing hole is tapered with its transverse cross-section being smallest at the center of the main body 32 of the head and gradually increasing toward both ends (see FIG. 1(b)), the insertion member 50, which has a uniform cross section, comes into line contact with the upper and lower sides of the inside of the bearing hole 40 at the center of the transfer head 30. Therefore, the transfer head 30 is capable of turning in the direction of an arrow in FIG. 1(c) about the position where the insertion member 50 comes into line contact with the inside of the bearing hole 40.

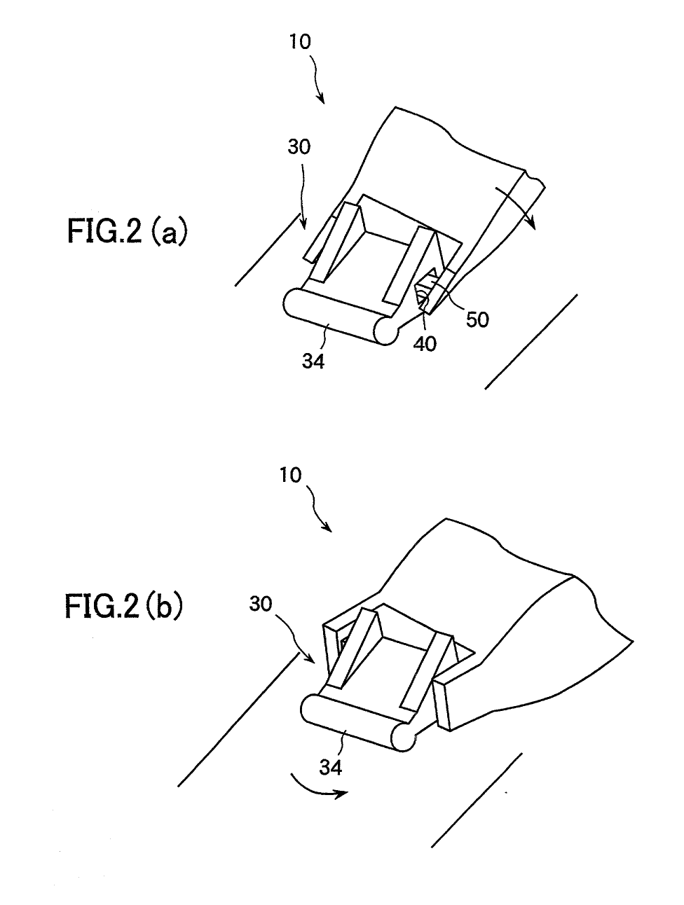

FIG. 2(a) shows the coating film transfer tool 10 inclined in the direction of an arrow, with the illustration of the transfer tape T omitted. As shown in FIG. 2(a), good transfer can be effected even when the coating film transfer tool 10 is inclined, because the transfer head 30 turns relative to the casing so that the entire length of the pressing part 34 can be pressed against a receiving surface.

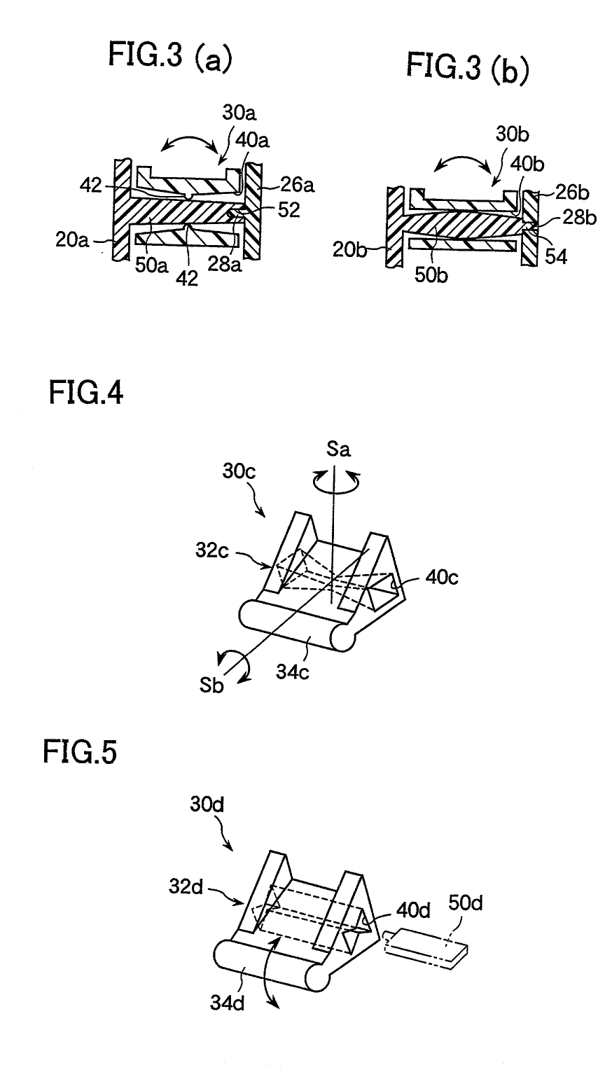

The bearing hole, of course, does not need to be smoothly tapered as in FIG. 1(c), and, with an appropriately shaped insertion member, the bearing hole need not be tapered at all. FIG. 3(a) and 3(b) show the combination of a transfer head and an insertion member in coating film transfer tools of second and third embodiments of the invention. Each of these figures corresponds to a cross-sectional view taken on plane C-C of FIG. 1.

In the transfer head 30a of FIG. 3(a), the upper and the lower walls of the bearing hole 40a are tapered and have a rectangular transverse cross-section as in FIGS. 1(b) and 1(c). However, the upper and lower walls have projections 42 provided inside the bearing hole 40a at its center in the width direction. The insertion member 50a is tapered toward one end thereof. In this embodiment, a recess 52 is provided at the end of the insertion member 50a, and a complementary projection 28a is provided on the back of a cover 26a. As shown in FIG. 3(a), when the insertion member 50a extends through the bearing hole 40a of the transfer head 30a, the projections 42, which are provided on the upper and lower sides of the inside of the bearing hole 40a, come into point contact with the insertion member 50a.

In the third embodiment, illustrated in FIG. 3(b), A bearing hole 40b, having a uniform transverse cross-section is provided in a transfer head 30b. On the other hand, an insertion member 50b used in this embodiment is formed so that its central part is the thickest. In this embodiment, a hole 28b extends through a cover 26b and a casing 20b and the cover 26b are united by causing a projection 54 at the end of the insertion member 50b to engage with hole 28b. When the insertion member 50b extends through the bearing hole 40b, the insertion member 50b comes into line contact with the upper and lower sides of the inside of the bearing hole 40b at the center of the bearing hole.

In each case, the transfer head 30a or 30b is rotatable in the direction of the arrow of FIG. 3(a) or 3(b). As a result, good transfer can be achieved even when the coating film transfer tool is inclined in use. The transfer head 30a or 30b can turn (as if the transfer tool were shaking its head) so that the full length of the pressing part can be pressed against a receiving surface.

In FIG. 4, the transfer head 30c in accordance with a fourth embodiment of the invention comprises a main head body 32c having a bearing hole 40c. The bearing hole has a rectangular transverse cross-section. All four sides (the upper, lower, right and left sides) of the bearing hole 40c taper toward the center of the bearing hole in the direction of the width of the transfer head. Thus, the transverse cross-section of the bearing hole 40c is smallest midway along the length of the hole, and gradually increases toward both ends. When an insertion member (not shown), also having a rectangular transverse cross-section, extends through the bearing hole 40c, the insertion member comes into line contact with the four walls of the bearing hole 40c at the location at which the transverse cross=section of the bearing hole 40c is the smallest. Therefore, the transfer head 30c is rotatable in the directions indicated by the arrows, about two axes, Sa and Sb, shown in FIG. 4, when installed in a coating film transfer tool. Thus, with this embodiment, it is possible for the transfer head 30 to turn (as if shaking its head) in a direction parallel to a receiving surface, as shown in FIG. 2(b).

In the fifth embodiment of the invention, as shown in FIG. 5, the main body 32d of a transfer head 30d, has a bearing hole 40d the transverse cross section of which is of uniform, bow-tie shape along the width of the main body 32d, being in the form of two intersecting triangles. The bearing hole extends parallel to the pressing part 34d.

When a rectangular, pillar-shaped, insertion member 50d extends through the bearing hole 40d, the bearing hole comes into line contact with the upper and lower sides of the insertion member 50d, allowing the transfer head 30d to rotate in the direction of the arrow of FIG. 5.

The coating film transfer tools of the second, third, fourth and fifth embodiments, are similar in operation to the transfer head of the first embodiment, except that the structure of the transfer heads 30a, 30b, 30c and 30d and/or the insertion member 50a, 50b and 50d differs from that of the corresponding parts in the first embodiment. In the coating film transfer tools of the alternative embodiments, since the transfer heads 30, 30a, 30b, 30c and 30d are mounted at the ends of the casings 20, 20a and 20b by insertion members 50, 50a, 50b and 50d, it is not necessary for extra space to be provided in the casings 20, 20a and 20b to accommodate the mounting of the transfer heads 30, 30a, 30b, 30c and 30d. As a result, the distance H, from the take-up core 24a to the end of the casing (see FIG. 1(a)) can be shortened and the coating film transfer tool as a whole can be miniaturized.

Moreover, the transfer heads 30, 30a, 30b, 30c and 30d may turned by a relatively small force, because the insides of the bearing holes 40, 40a, 40b, 40c and 40d come into line or point contact with the insertion members 50, 50a, 50b and 50d. As a result, good quality transfer can be accomplished, since the transfer heads 30, 30a, 30b, 30c and 30d respond to the inclination of the coating film transfer tool instantly, and turn smoothly, so that the entire lengths of the pressing parts, e.g. 34, 34c and 34d, and the corresponding pressing parts (not shown) of the embodiments of FIGS. 3(a) and 3(b), can be pressed against a receiving surface.

By engaging the insertion members 50, 50a, 50b and 50d, provided in the casings 20, 20a and 20b, with the engaging parts 28, 28a and 28b of the covers 26, 26a and 26b, the transfer heads 30, 30a, 30b, 30c and 30d are mounted in a simple manner, and the casings 20, 20a and 20b are united with their covers 26, 26a and 26b.

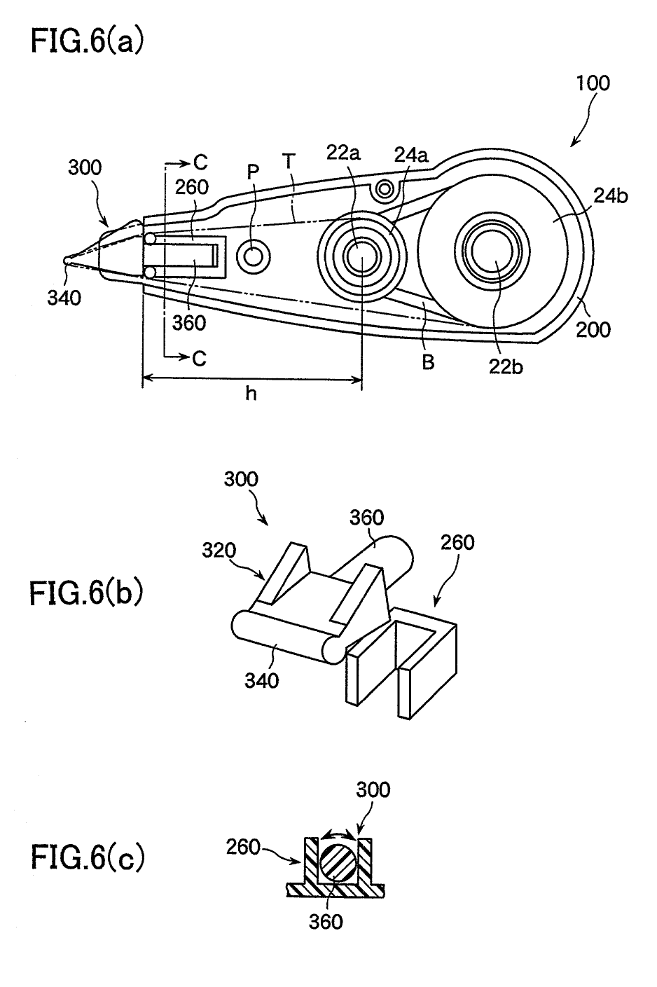

In a conventional coating film transfer tool, it is necessary to set up an insertion pin (for example pin P of FIG. 6) in the vicinity of a transfer head, to unite a casing with a cover. However, such an insertion pin does not need to be provided separately in the coating film transfer tool according to the invention.

In the above-described coating film transfer tool, it is acceptable for the insertion members 50, 50a, 50b and 50d to be molded as a unit with the casings 20, 20a and 20b or to mold them as separate bodies and later mounting them in the casings. If the insertion members are formed separately from the casings, the transfer head may be mounted in the coating film transfer tool and at the same time that the casing is united with the cover. This is achieved by providing one end of the insertion member in the casing, and inserting the other end into the cover.

In addition, an acceptable coating film transfer tool can be assembled, using an insertion member formed by a spring, or a plastics material which has flexibility, such as ABS (acrylonitrile butadiene styrene), PP (polypropylene) and PE (polyethylene), and so on. When the transfer head of the coating film transfer tool is pressed against a receiving surface, the transfer head is permitted to turn as a result of elastic deformation of the insertion member.

Although the bearing holes in the embodiments shown in the drawings extend through the main body of the transfer heads, the bearing hole and the insertion member do not necessarily need to extend entirely through the transfer head. For example, it an acceptable transfer tool can be formed with a cantilevered projection, inserted into a blind bearing hole.

Although not illustrated, both lateral sides of the transfer head may be made convex, for example spherically convex. When so shaped, the transfer head can turn easily even if the main body of the transfer head comes into contact with the side walls of the casing at the end from which the transfer head projects.

In the coating film transfer tool according to the invention, since the main body of the transfer head itself may be mounted rotatably in the casing, even when the coating film transfer tool is inclined while being used, the transfer head is capable of rotating, the entire length of the pressing part may be pressed against a receiving surface, and effective transfer of the coating film can be achieved. Since extra space is not necessary in the casing in order to mount the transfer head the coating film transfer tool may be miniaturized as a whole. Even when the base material of the transfer tape is a thin tape base material having relatively weak elasticity, twisting, meandering, and folding of the transfer tape is minimized.

What is claimed is:

1. A coating film transfer tool comprising a casing, a supply core and a take-up core, both disposed rotatably in the casing, a transfer head having a main body and a pressing part, the pressing part protruding in a first direction from an end of the casing, and a transfer tape wound on the supply core, wherein the transfer tape includes a tape base material which extends around the pressing part to the take-up core, and a transferable coating film, which is separable from the tape base material at the location of the pressing part, for transfer onto a receiving surface while the remaining tape base material is wound onto the take-up core, and
wherein the improvement comprises a bearing hole in said main body of the transfer head, the bearing hole extending in a second direction transverse to said first direction, and an insertion member extending into said bearing hole at said end of the casing.

2. A coating film transfer tool as claimed in claim 1, wherein the bearing hole is tapered, having its smallest cross-section approximately at the center of the transfer head.

3. A coating film transfer tool as claimed in claim 1, wherein said bearing hole is a through hole and said insertion member extends through said through hole.

4. A coating film transfer tool as claimed in claim 3, wherein the bearing hole is tapered, having its smallest cross-section approximately at the center of the transfer head.
